(19) United States
(12) Patent Application Publication
(10) Pub. No.: US 2020/0100424 A1
(43) Pub. Date: Apr. 2, 2020

(54) SYSTEM AND METHOD FOR METERING AMMONIA ANHYDROUS

(71) Applicant: Deere & Company, Moline, IL (US)

(72) Inventors: Scott M. Buse, Adel, IA (US); Brandon M. McDonald, Johnston, IA (US)

(21) Appl. No.: 16/148,537

(22) Filed: Oct. 1, 2018

(51) Int. Cl. A01C 23/00; A01C 23/02

(52) U.S. Cl. CPC A01C 23/007; A01C 23/024

(57) ABSTRACT

A distributed metering system and method for metering liquid anhydrous ammonia is disclosed. The distributed metering system can comprise a plurality of applicator devices coupled to a plurality of metering units, and an electronic control unit coupled to the plurality of metering units. The electronic control unit is configured to control an application rate of a crop input material supplied from the plurality of metering units by adjusting an operating parameter of a component of each of the plurality of metering units when the application rate exceeds or falls below a predetermined threshold.

### FIELD OF THE DISCLOSURE

The present disclosure relates generally to metering units, and, more particularly, to a system and method for metering liquid anhydrous ammonia.

### BACKGROUND OF THE DISCLOSURE

In agricultural applications, a variety of fertilizers and chemical compounds are delivered to the soil to aid in the growth and development of crops and plants. A commonly used fertilizer is anhydrous ammonia. Although anhydrous ammonia has been used as an agricultural fertilizer for many years, problems remain in achieving efficient and effective delivery of the compound into the soil. For example, due to its chemical make-up, anhydrous ammonia can be supplied in liquid or gas form. In liquid form, anhydrous ammonia is generally stored in a pressurized tank. During delivery expansion of the liquid can lead to temperature drops, resulting in an evaporation of the liquid in to a gas phase.

To address such concerns, some conventional systems employ the use of systems in which the total volume of product is measured upstream prior to separating the liquid for distribution into the soil. Drawbacks, however, include uncontrollable variations in the application rate due to factors such as hose lengths, hose restrictions, impellicone distribution errors, and/or liquid vaporization. As such, there is a need in the art for a robust and cost-effective metering and application system that provides improved metering accuracy.

### SUMMARY OF THE DISCLOSURE

According to an aspect of the present disclosure, a distributed metering system and method is disclosed. The distributed metering system can comprise a plurality of applicator devices coupled to a plurality of metering units, and an electronic control unit coupled to the plurality of metering units. The electronic control unit is configured to control an application rate of a crop input material supplied from the plurality of metering units by adjusting an operating parameter of a component of each of the plurality of metering units when the application rate exceeds or falls below a predetermined threshold.

Other features and aspects will become apparent by consideration of the detailed description and accompanying drawings.

### BRIEF DESCRIPTION OF THE DRAWINGS

The detailed description of the drawings refers to the accompanying figures in which:

FIG. 1 is an illustration of an agricultural application system having a distributed metering system arranged therein according to an embodiment;

FIG. 2 is a block diagram of a distributed metering system according to an embodiment;

FIG. 3 is a block diagram of a metering unit arranged in the distributed metering system of FIG. 2 according to an embodiment; and

FIG. 4 is a block diagram of a distributed metering system according to an embodiment.

Like reference numerals are used to indicate like elements throughout the several figures.

### DETAILED DESCRIPTION OF THE DRAWINGS

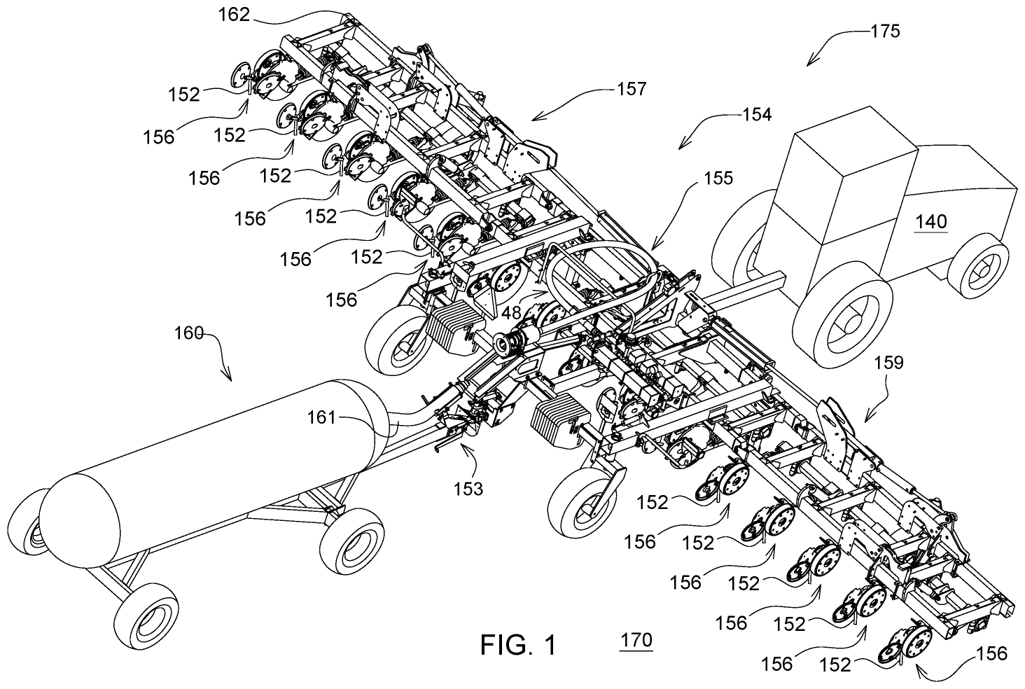

Referring to FIG. 1, a distributed metering system 100 arranged in an agricultural application system 150 is shown according to an embodiment. The agricultural application system 150 can comprise a work vehicle 140 that is arranged to tow an agricultural implement 154 having a solution tank 160 attached thereto across a worksite 175.

As depicted in FIG. 1, the agricultural implement 154 can comprise a plurality of ground engaging elements 156 attached to a frame 162. Each of the plurality of ground engaging elements 156 can be arranged to extend downwardly and away from the agricultural implement 154 (e.g., in a direction generally perpendicular to a longitudinal axis of the agricultural implement). The arrangement of the ground engaging elements 156 allows for soil cultivating tasks to be performed such as creating openings (e.g., holes, slivers, slices, trenches or furrows) in the soil 170. Although the exemplary embodiments herein depict the ground engaging elements 156 as including an opener arrangement, it should be noted that, in other embodiments, the ground engaging elements 156 can include disk harrows, coulters, shanks, or other suitable elements that are arranged to create openings in the soil 170 for dispensing ammonia or fertilizer in association with the application system 150.

A plurality of applicator devices 152 can be removably coupled, e.g., mounted behind or underneath, the agricultural implement 154 with respect to the direction of travel of the work vehicle 140. In various embodiments, the applicator devices 152 (i.e., liquid dispensers) can include tubular, conical, funnel-shaped, syringe or other suitable dispenser shapes that are configured to accurately apply the crop input materials (i.e. liquid anhydrous ammonia) to small areas (e.g. within approximately 1-2 inches of a desired location). For example, in some embodiments, the plurality of applicator devices 152 can comprise one or more nutrient knives arranged proximate the ground engaging elements 156 (arranged rearward of the opener arrangement). The nutrient knives can be arranged to direct crop input materials received from the solution tank 160 into the soil 170 simultaneously as it is being prepared or cultivated. For example, the nutrient knives, alone or together with an opener or opener disk, may create a furrow or groove in the soil 170 for accepting the ammonia or nitrogen, whereas a closer or other trailing device cover the furrow.

The solution tank 160 can be mechanically coupled to the agricultural implement 154 via a link 153 and can be arranged to trail rearward of the agricultural implement 154 in some embodiments. The solution tank 160 can comprise a pressurized tank that stores liquid anhydrous ammonia (NH₃) or other suitable crop input materials for supply to the plurality of applicator devices 152. For example, in some embodiments, the solution tank 160 can be arranged to provide the liquid NH₃ to one or more distribution conduits 155 for supply to the applicator devices 152 via distributed metering system 100.

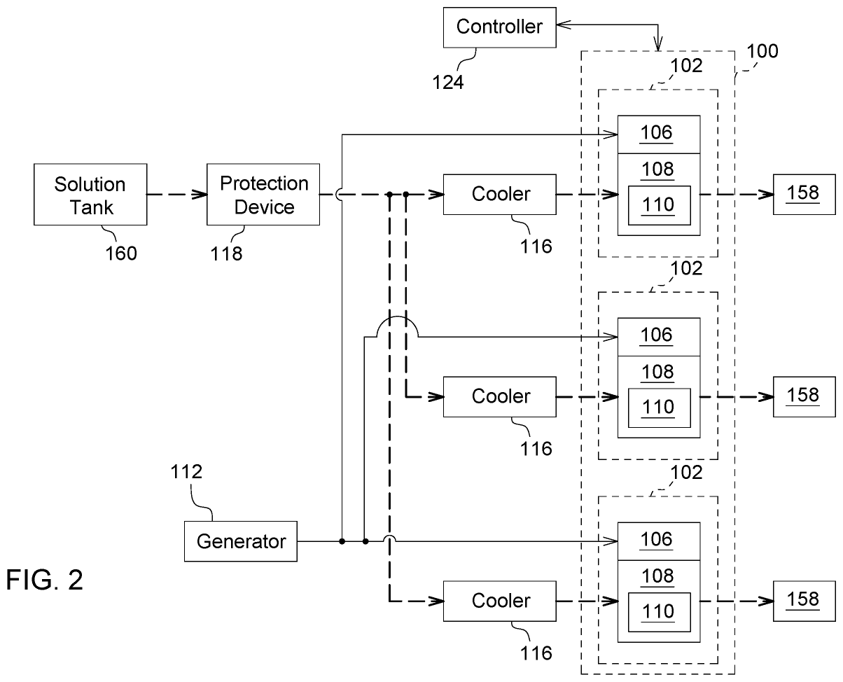

The distributed metering system 100 can comprise a plurality of metering units 102 respectively coupled to a corresponding applicator device 152 to provide row by row metering of the liquid NH₃, as will be discussed in further detail with reference to FIG. 2. Although not shown, it should be noted that, in other embodiments, sectional metering of the NH₃ can be provided by coupling each of the metering units 102 to one or more groups of the applicator devices 152.

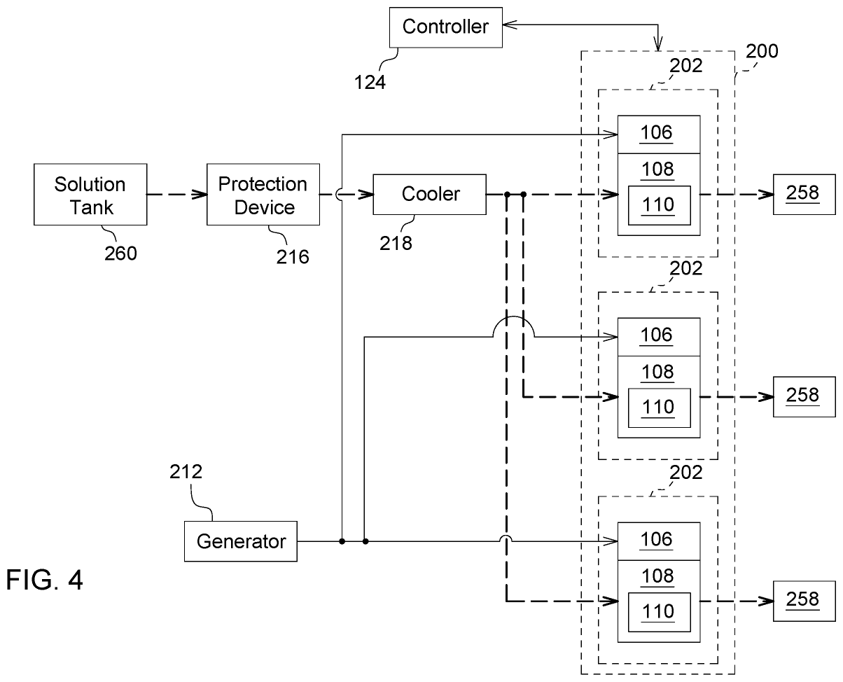

With respect to FIG. 1, it will be appreciated by those skilled in the art that FIG. 1 is not drawn to scale and is for illustrative purposes only to demonstrate exemplary embodiments of the present disclosure. Notably, the structural layout and/or quantity of the various components can and will vary in other embodiments. For example, in other embodiments, one or more applicator devices 152 can be attached to the rear of the work vehicle 110, either in the lateral direction (e.g. perpendicular to direction of travel) or in parallel relation to allow for multiple types of nutrients to be dispensed. In still other embodiments, the arrangement of the cooling device 116 can and will vary as will be discussed with reference to FIGS. 2 and 4.

Referring to FIGS. 2-4, a more detailed depiction of the distributed metering system 100 is shown according to an embodiment. As discussed with reference to FIG. 1, the distributed metering system 100 can comprise the plurality of metering units 102 each comprising one or more dispensing units 108 coupled to an electric machine 106 (e.g., an asynchronous permanent magnet motor). Each of the metering units 102 can be communicatively coupled to an electronic data controller 124, which can be arranged locally, e.g., on the work vehicle 140, or remotely at data processing center. In embodiments, the electronic data controller 124 can comprise a microprocessor, a microcontroller, a central processing unit, a programmable logic array, a programmable logic controller, an application specific integrated circuit, a logic circuit, an arithmetic logic unit, or another data processing system for processing, storing, retrieving, or manipulating electronic data associated with the metering units 102.

Each of the metering units 102 can be arranged such that an application rate of the crop input material (i.e., liquid NH₃) dispensed from the dispensing unit 108 is determined based on a speed of the electric machine 106. Power to the electric machine 106 can be provided by a power generation device 112, which can be arranged on the agricultural implement 154 or arranged as part of a power take-off (PTO) system of the work vehicle 140. In some embodiments, the electric machine 106 can be communicatively coupled to the electronic data controller 124 (e.g., via a wired or wireless connection). In other embodiments, the electric machine 106 can be integrally formed as a single unit with the dispensing unit 108 and may also comprise an onboard processor to provide additional processing capabilities. Additionally, although in embodiments discussed herein the metering system 100 will be shown as including a centralized system, in other embodiments, each of the metering units 152 can be configured to engage in peer-to-peer communication.

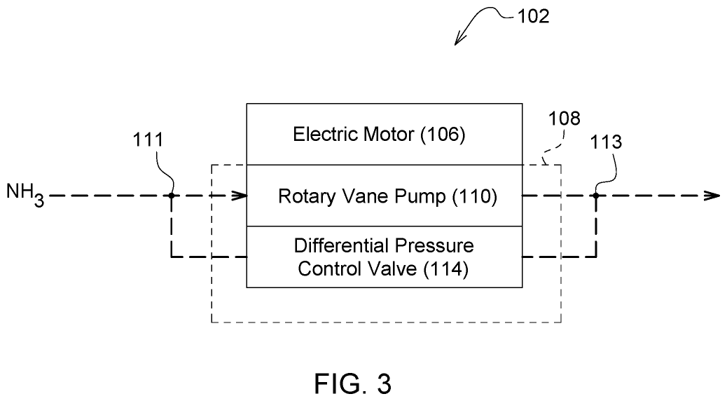

As depicted in FIG. 3, the dispensing unit 108 can comprise a pump device 110 having a regulator device 114 coupled across an inlet 111 and an outlet 113 of the pump device 110. In various embodiments, the pump device 110 can comprise a variety of positive displacement pumps including, without limitation, rotary vane pumps, axial piston pumps, inline piston pumps, bent-axis pumps, radial-piston pumps, plunger pumps that supplies the crop input material to the plurality of applicator devices 152. In one embodiment, the regulator device 114 can comprise a differential pressure control valve that is configured to monitor pressure differentials across the pump device 110. For example, if the monitored pressure differentials exceed or fall below a desired threshold, an output of the regulator device 114 can be proportionally adjusted via the electronic data controller 124 to maintain a constant pressure. This in turn allows for independent control and regulation of the system pressure irrespective of the application rate and speed of the electric machine 106.

In some embodiments, a cooling device 116 can be arranged at an inlet of the pump device 110 (FIG. 2) to maintain temperatures of the anhydrous ammonia to limit liquid expansion which could result in pressure drops and gas formation. In other embodiments, the arrangement of the cooling device may vary according to design and application requirements. For example, referring now to FIG. 4, a distributed metering system 200 is shown, which is substantially similar to system 100 with the exception of the arrangement of the cooling device 116. As depicted in FIG. 4, a cooling device 216 can be arranged upstream of the distributed metering system 200 in a location intermediately between the solution tank 260 and a protection device 218. In such an arrangement, cooling of the liquid anhydrous ammonia is centralized rather than locally cooling the fluid at each of the metering units 202.

FIGS. 2 and 4 are but two exemplary embodiments, the arrangement of the cooling device 116, 216 can vary in other embodiments according to design and/or specification requirements. Further, it should be noted that in either of the respective embodiments of FIGS. 2 and 4, the arrangement of the cooling device 116, 216 is particularly advantageous in that it provides for continuous cooling of the liquid NH₃ as it is being supplied to the respective applicator device 152. For example, such an arrangement helps to reduce variability and fluctuations in the fluid supply and prevent temperature increases, which could adversely affect the uniformity of the fluid supply.

The protection device 118 can be arranged upstream of the distributed metering system 100 and coupled to an input supply line (e.g., the distribution conduits 155 or a distribution manifold) of the distributed metering system 100. In some embodiments, the protection device 118 can comprise a safety valve that is manually controlled by an operator between an on/off position. In other embodiments, the protection device 118 can be communicatively coupled to the electronic data controller 124 and arranged such that an output of the protection device 118 is controlled by the electronic data controller 124 to allow for selective coupling and decoupling the metering system 100 from the supply source for maintenance or emergency purposes. Additionally, although not shown, in still other embodiments, one or more protection devices (i.e., protection device 118) can be directly coupled to each of the metering units 102 to provide individualized control of each of the metering units 102.

In operation, initial set point parameters can be entered by an operator via an operator interface arranged locally in the work vehicle 140 or remotely at a remote processing center. Additionally, before or during vehicle startup, each or a select group of the metering units 102 can be enabled via the electronic data controller 124. Once the initial parameters are received, the speed of the electric machine 106 and dispensing unit 108 are controlled by the electronic data controller 124 to meter a prescribed rate of anhydrous of the liquid anhydrous ammonia. For example, the metering system 100, 200 distributes the liquid anhydrous ammonia on a row by row basis. The application rate for each row can be controlled independently via the speed of the electric machine 106 and each row can be shut off independently.

As the work vehicle 140 travels across the worksite 175, the liquid anhydrous ammonia is supplied from the solution tank 160 (i.e., supply source) to the cooling device 116 and distributed through the metering units 102 to one or more conduits 155 (i.e., row by row) before being supplied to the applicator devices 152. For example, because the system parameters are monitored in real time, an operator or the electronic data controller 124 can dynamically adjust system set points to ensure uniform application of the liquid anhydrous ammonia is achieved. Additionally, in some embodiments, the arrangement of the distributed metering system 100 is such that fluid flow to each of the metering units 104 can be manually shut off by an operator via the protection device 118.

In other embodiments, the application rate may be controlled according to the turning angle of the work vehicle 140. For example, during turns, variances within the application rate can result, which can lead to non-uniform applications or potential leakage. Therefore, to compensate for such variances, the electronic controller 124 can be configured to adjust the application rate based on a turning radius of the work vehicle 140 to apply the correct amount of product across the width of the bar when in a turn. In still other embodiments, the distributed metering system 100 can be further configured as a monitoring system. For example, fluid blockage within one or more of the applicator devices 152 can be detected by monitoring the amount of current being supplied to the electric machine 106. In such an arrangement, if the measured current exceeds a predetermined threshold, a blockage of flow within the applicator devices 152 can be detected by correlating the measured current value to a desired flow output.

Once the liquid anhydrous ammonia is released into the soil 170 via the applicator devices 152, the closing disks 114 push the soil 170 back over the furrow created by the opener disk 100 to trap the compound within the soil 170.

Without in any way limiting the scope, interpretation, or application of the claims appearing below, a technical effect of one or more of the example embodiments disclosed herein is a system and method for metering the liquid anhydrous ammonia. The system is particularly advantageous in that it allows for row by row metering of anhydrous ammonia.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A distributed metering system, the distributed metering system comprising:
a plurality of applicator devices;
a plurality of metering units coupled to one or more of the plurality of applicator devices; and
an electronic control unit coupled to the plurality of metering units, wherein the electronic control unit is configured to control an application rate of a crop input material supplied from the plurality of metering units by adjusting an operating parameter of a component of each of the plurality of metering units when the application rate exceeds or falls below a predetermined threshold.

2. The distributed metering system of claim 1, wherein each of the plurality of applicator devices are coupled to or arranged proximate one or more ground engaging devices arranged on an agricultural implement.

3. The distributed metering system of claim 1, wherein each of the plurality of metering units comprises at least one pump device coupled to an electric machine.

4. The distributed metering system of claim 3, wherein the pump device comprises a variable displacement pump including one or more of the following: a rotary vane pump, an axial piston pump, an inline piston pump, a bent-axis pump, a radial-piston pump, a plunger pump.

5. The distributed metering system of claim 3, wherein adjusting the operating parameter of the component of each of the plurality of metering units comprises adjusting a speed of an electric machine.

6. The distributed metering system of claim 5, wherein each of the plurality of metering units are selectively activated and deactivated based on the speed of the motor on a row-by-row basis.

7. The distributed metering system of claim 1, wherein an application rate of the crop input material is adjusted based on a turning radius of a work vehicle.

8. The distributed metering system of claim 1 further comprising a cooling device arranged proximate to or within the distributed metering system, wherein the cooling device is configured to maintain a temperature of the crop input material to minimize expansion of the crop input material.

9. The distributed metering system of claim 1, wherein the crop input material comprises liquid anhydrous ammonia.

10. A distributed metering system for an agricultural application system, the distributed metering system comprising:
an agricultural implement;
a plurality of liquid dispensers arranged on the agricultural implement;
a distributed metering system comprising a plurality of metering units coupled to one or more of the plurality of liquid dispensers; and
an electronic control unit coupled to the plurality of metering units, wherein the electronic control unit is configured to control an application rate of the crop input material supplied from the plurality of metering units by adjusting an operating parameter of a component of each of the plurality of metering units when the application rate exceeds or falls below a predetermined threshold, or based on a turn radius of a work vehicle.

11. The distributed metering system of claim 10, wherein each of the plurality of liquid dispensers are coupled to or arranged proximate one or more ground engaging devices.

12. The distributed metering system of claim 10, wherein each of the plurality of liquid dispensers comprises one or more of the following: a dispensing tube, a syringe, a nutrient knife, or combinations thereof.

13. The distributed metering system of claim 10 further comprising one or more cooling devices respectively coupled to each of the plurality of metering units.

14. The distributed metering system of claim 10, wherein an application rate of the crop input material is adjusted based on a turning radius of a work vehicle.

15. The distributed metering system of claim 10, wherein the metering unit comprises a pump device coupled to an electric machine, and wherein adjusting the operating parameter of the component of each of the plurality of metering units comprises adjusting a speed of an electric machine.

16. The distributed metering system of claim 15, wherein each of the plurality of metering units are selectively activated and deactivated based on the speed of the motor on a row-by-row basis.

17. The distributed metering system of claim 16, wherein the crop input material comprises liquid anhydrous ammonia.

18. A method for metering a crop input material, the method comprising:
receiving a first signal to activate one or more metering units;
determining an operating parameter of a component of the one or more metering units;
associating the operating parameter of a component of the one or more metering units with an application rate of the crop input material;
monitoring the application rate of the crop input material; and
dynamically adjusting the operating parameter of the component of the one or more metering units on a row-by-row basis to maintain the application rate within a desired threshold.

19. The method of claim 18, wherein the operating parameter of the component of each of the plurality of metering units comprises a speed of an electric machine.

20. The method of claim 18 further comprising adjusting the application rate of the crop input material based on turn radius of a work vehicle.
